(19) United States
(12) Patent Application Publication
(10) Pub. No.: US 2011/0074130 A1
(43) Pub. Date: Mar. 31, 2011

(54) STEP BOARD

(75) Inventor: Seong-Jin Park, Gyeonggi-do (KR)

(73) Assignee: HUMANIC CO., LTD., Gyeonggi-do (KR)

(21) Appl. No.: 12/301,274

(22) PCT Filed: Jun. 26, 2008
(86) PCT No.: PCT/KR2008/003675

§ 371 Date: Nov. 18, 2008

(30) Foreign Application Priority Data
Jun. 19, 2008 (KR) 10-2008-0057969

(51) Int. Cl. B62M 1/04; B60T 1/06

(52) U.S. Cl. 280/221

(57) ABSTRACT

The invention concerns a step board and the object of the invention is to provide a step board provided with a braking device to be stable and good in steering and propulsion performance. The step board of the invention in order to achieve the aforementioned object is characterized by comprising a first frame in which a directional caster is equipped at the front end and the back end of a main axis, respectively, a left foothold being extending left upward in the middle of the main axis in length, and a right foothold extending right upward, a second frame crossing the main axis and extending in the right and left directions, a directional caster being provided at each of the right and left ends thereof, and hinge-coupled to the first frame, and a plurality of coil springs one end of which is coupled to the first frame and the other end of which is coupled to the left and right sides of the second frame, respectively.

### TECHNICAL FIELD

The present invention relates to a step board, in particular, provided with a braking device to be stable and good in steering and propulsion performance.

### BACKGROUND ART

The step board disclosed in the published Korea Registered Patent No. 800570 (title of the invention: A Step Board) does not have a braking device, so that it has some problems in safety. Also, a conventional step board has non-direction restoring casters which 360-degree rotate and can't go intended way when they are hit by an obstacle, e.g., cobbles or stones, or run on an unpaved road while a user is on his step board, so that he is thereby also out of balance, thus may fall off his step board or may not go straight on his step board in a desired direction.

Also, as such, since the directional caster aforementioned is not of direction restoring performance, it is not easy to use a step board provided with the conventional casters when a user stands on the footholds to generate the force of propulsion.

### DISCLOSURE OF INVENTION

### Technical Problem

The invention was devised to address the aforementioned prior art problems. It is an object of the present invention to provide a safe step board provided with an automatic braking device which operates when a user gets off his step board in order to catch the step board not to continue to run and thus to stop it, and which enables speed to be reduced by loading his weight.

It is another object of the invention to provide a step board equipped with direction restoring casters, so that, although the casters do staggered running because of external impact or obstacles, they quickly recover intended direction by means of the force of resilience thereof and which is structured so that a user can easily generate the force of propulsion while standing on the footholds.

### Technical Solution

The step board of the invention in order to achieve the aforementioned object of the invention is characterized in that it comprises a first frame in which a directional caster is equipped at the front end and the back end of a main axis, respectively, a left foothold being extending left upward, and a right foothold extending right upward from the middle of the main axis in length, respectively, a second frame crossing the main axis and extending in the right and left direction, a directional caster being provided at each right and left end of the second frame which is hinge-coupled to the first frame, and a plurality of coil springs one end of which is coupled to the first frame and the other end of which is coupled to the left and right sides of the second frame, respectively.

Also, according to a preferred embodiment of the invention, a lug extending upward is formed in the main axis and a projection extends upward from the second frame, the projection and the lug being hinge-coupled.

Also, according to another preferred embodiment of the invention, the directional caster is a direction restoring caster equipped with a plural number of coil springs therein so that the wheels return their original state by means of the force of resilience.

Also, according to still another preferred embodiment of the invention, each of the direction restoring casters provided on the right and left ends of the second frame is equipped to be widened forward and narrowed backward gradually with respect to the central line of the main axis.

Also, according to still another preferred embodiment of the invention, the right and left footholds are formed to have a lower front side than the backside in an inclined way, and the inner side is formed to be lower than the outer side in an inclined way.

Also, according to still another preferred embodiment of the invention, the back end of the main axis is provided with a braking means extending toward the side facing away the directional caster equipped at the back end, and positioned toward the ground.

Also, according to still another preferred embodiment of the invention, the step board further comprises an automatic braking device which releases braking of the directional caster equipped at the back end of the main axis when a load is given on the right and left footholds and brakes the directional caster equipped at the back end of the main axis when the load is removed.

### ADVANTAGEOUS EFFECTS

The step board of the invention is advantageous in that it is safe to use it in that it is possible to control the speed thereof by means of the braking means.

Also, since the step board of the invention is provided with an automatic braking device for automatically braking it when a user gets off the foothold, it is avoided that the step board does not stop and continues to run by means of inertia although the user gets off the footholds. Therefore, collision accidents can be prevented which occur by means of a step board which continues to run by means of inertia or is uncontrollable and the step board of the invention is advantageous in that it addresses the problem that a user has to run to catch the step board running without stopping at a place where he gets it off.

Also, the step board of the invention is advantageous in that the direction restoring caster is provided at an angle to be suitable for generating the force of propulsion when the user is on the footholds in order to enhance the force of propulsion.

Also, the step board of the invention can quickly recover orientation by means of resilience although the casters run in a staggering way because of external impact or an obstacle while running, so that safety accidents can be avoided which occur when the user loses his balance and may fall off the footholds to be injured. Furthermore, the step board is provided with a resilient object to recover the inclined footholds to the original state for a user to achieve easy stepping and thus to allow running for a long time and at a high speed as desired.

### BRIEF DESCRIPTION OF THE DRAWINGS

These and other features, aspects, and advantages of the present invention will become apparent through the following description, illustrated in the appended drawings, in which like components are referred to by like reference numerals. The various features of the drawings may not be to scale. In the drawings:

FIG. 1 is a perspective view illustrating a step board according to the invention;

FIG. 2 is a side view of the step board shown in FIG. 1;

FIG. 3 is a top view of the step board shown in FIG. 1;

FIG. 4 is a perspective view illustrating the state that a foothold cover and a hinge cap are removed in the step board shown in FIG. 1;

FIG. 5 is an exploded and perspective view of the step board shown in FIG. 1;

FIG. 6 is a front view illustrating the direction in which a directional caster moves when a first frame is inclined toward the left side at the state shown in FIG. 4;

FIG. 7 is a front view illustrating the direction in which a directional caster moves when a first frame is inclined toward the right side at the state shown in FIG. 4;

FIG. 8 is an exploded and perspective view of a second direction restoring caster shown in FIG. 1;

FIG. 9 shows a cross section illustrating the state that braking the automatic braking device of the second direction restoring caster shown in FIG. 8 is released; and

FIG. 10 shows a cross section showing the state that the automatic braking device of the second direction restoring caster shown in FIG. 8 achieves braking.

### REFERENCE NUMERALS IN THE FIGURES

| | |
|---|---|
| 100: automatic braking device | 120: lever |
| 130: bracket | 140: braking axis |
| 150: coil spring | 160: back wheel |
| 162F: front wheel | 162L: left wheel |
| 162R: right wheel | 171: protrusion |
| 175: caster bolt | 200: step board |
| 210: first frame | 211: main axis |
| 213L, 213R: foothold | 220: second frame |
| 221: projection | 223: hinge |
| 230: compression coil spring | |

### MODE FOR THE INVENTION

Hereinafter, preferred embodiments of the step board according to the present invention will be described in detail with reference to the accompanying drawings.

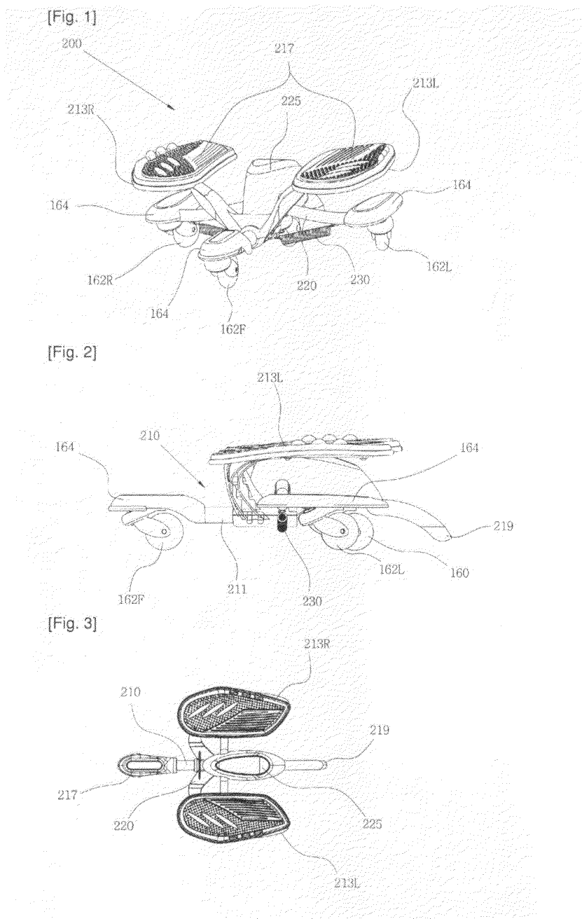

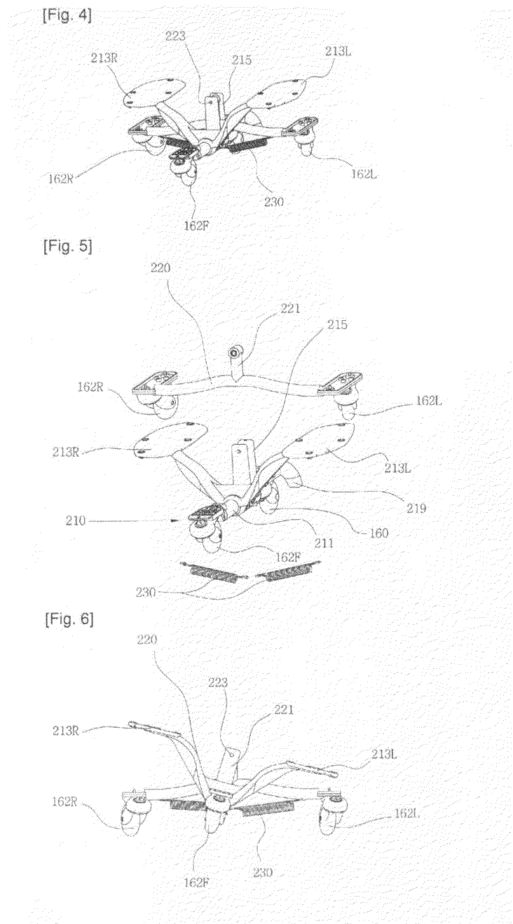

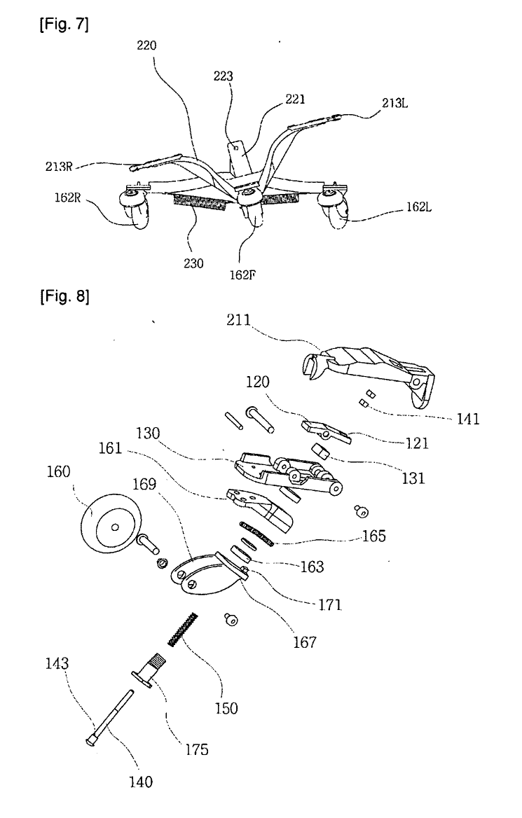

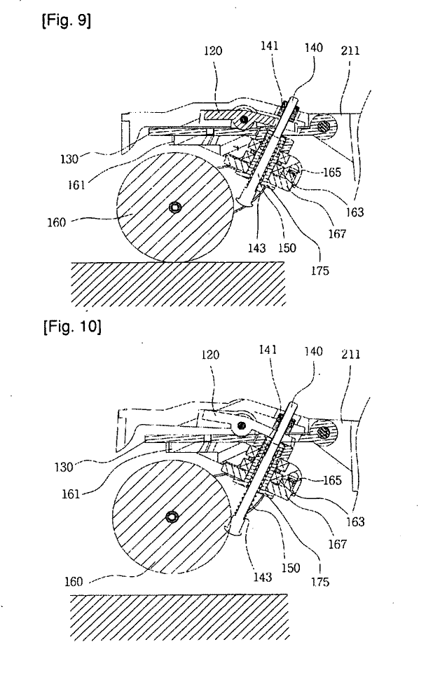

In the drawings, FIG. 1 is a perspective view illustrating a step board according to the invention, and FIG. 2 is a side view of the step board shown in FIG. 1. FIG. 3 is a top view of the step board shown in FIG. 1 and FIG. 4 is a perspective view illustrating the state that the foothold cover and the hinge cap are removed in the step board shown in FIG. 1. FIG. 5 is an exploded and perspective view of the step board shown in FIG. 1. FIG. 6 is a front view illustrating the direction in which a directional caster moves when the first frame is inclined toward the left side at the state shown in FIG. 4. FIG. 7 is a front view illustrating the direction in which a directional caster moves when the first frame is inclined toward the right side at the state shown in FIG. 4. Furthermore, FIG. 8 is an exploded and perspective view of a second direction restoring caster shown in FIG. 1. FIG. 9 shows a cross section illustrating the state that braking of the automatic braking device of the second direction restoring caster shown in FIG. 8 is released. FIG. 10 shows a cross section illustrating the state that braking of the automatic braking device of the second direction restoring caster shown in FIG. 8 is performed.

As shown in FIGS. 1 to 3, the step board 200 comprises a first frame 210, a second frame 220, and compression coil springs 230 for connecting the first and second frames 210 and 220.

The first frame 210 comprises a main frame 211 equipped with a first direction restoring caser 162F (hereinafter, referred to ‘a front wheel’) at its front end and with a second direction restoring caster 160 (hereinafter, referred to ‘a back wheel 160’) at its back end, a left foothold 213L extending left upward from the middle of the main axis 211 in length, a right foothold 213R extending right upward from the middle of the main axis 211 in length, and a pair of lugs 215 extending upward from the main axis 211 to allow the second frame 220 to be hinge-coupled between the right and left footholds 213R and 213L and the back wheel 160.

The second frame 220 crosses the main axis 211 to extend in the right and left directions and is equipped with a first direction restoring caster (hereinafter, referred to ‘a left wheel 162L’) at its left end and a first direction restoring caster (hereinafter, referred to ‘a right wheel 162R’) at its right end. In the middle of the second frame 220 in length, a projection 221 extending upward is hinge-coupled 223 to the lug 215.

Two compression coil springs 230 couple the first frame 210 to the second frame 220, one end of which is fixed to the main axis 211 and the other end of which is connected to the left side and the right side of the second frame 220, respectively.

Therefore, as shown in FIGS. 4 and 5, when the first frame 210 is inclined to the left or right side on the basis of the hinge 223 connected to the second frame 220, the left foothold 213L and the right foothold 213R of the first frame 210 inclined are provided with the force of resilience in order to be horizontally placed, while the compression coil spring in the direction in which the first frame 210 is inclined extends and the compression coil spring on the opposite side shrinks.

The running principle of the step board 200 configured as described above is the same as that of a step board disclosed in the published Korea Patent Registration No. 800570 (title of the invention: A Step Board), as shown in FIGS. 6 and 7. Therefore, detailed description of the running principle of the step board will not be given herein.

The step board configured as described above will be described in more detail hereinafter.

The lower side of the front end of the first frame 210 and each of the lower sides of the right and left ends of the second frame 220 are equipped with a front wheel 162F, a left wheel 162L and a right wheel 162R, respectively. Covers 164 are provided to hide the bolts and nuts for fixing the front wheel 162F, the left wheel 162L and the right wheel 162R. Foothold covers 217 are provided on top of the left foothold 213L and the right foothold 213R so that a user does not slip off while feeling the ground pressure or the cushion effect when he is on the right and left footholds 213L and 213R.

In addition, the left wheel 162L and the right wheel 162R are equipped to be kept at an angle of 10 to 20 degrees by widening forward and narrowing backward gradually with respect to the direction of running, that is, the center line of the main axis 211. This is because the step board structured as such is superior to a conventional step board in which its left and right wheels are equipped to be in parallel to the main axis, in terms of propulsion performance.

Also, the right and left footholds are formed so that the front side thereof is inclined to be about 3 degrees lower than the back side, and the inner side is lower than the outer side to be inclined. This is an ergonomic structure to allow a user easily to incline the first frame 210 in the right and left directions while he is on the right and left footholds 213R and 213L and then slightly bends his body.

The lug 215 for hinge 223-coupling the first frame 210 to the second frame 220 is covered with a hinge cover 225. The hinge 223-coupling point is where the first and second frames 210 and 220 rotate and it is preferred to cover the point with the hinge cover 225 in order to prevent safety accidents.

Furthermore, a braking means 219 made of rubber is formed at the back end of the main axis 211 facing away the back wheel 160 and toward the ground. Therefore, when the user standing on the right and left footholds 213R and 213L inclines slightly backward, the braking means 219 contacts the ground while the main axis 211 inclines backward with respect to the right and left wheels 162R and 162L. The reason that the braking means 219 contacts the ground when the user inclines backward as described above is because the front wheel 162F and the right and left wheels 162R and 162L form an equilateral triangle. Accordingly, friction occurs while the braking means 219 contacts the ground, so that the running step board 200 decelerates.

Hereinafter, characteristics of the automatic braking device 100 and the first and second direction restoring casters will be described in more detail.

As shown in FIGS. 8 to 10, the automatic braking device 100 comprises a bracket 130 of which the front end is hinge-coupled to the main axis 211 of the step board 200 and which is equipped with the back wheel 160 on its lower side, a lever 120 of which the intermediate portion in length is hinge-coupled to the upper side of the bracket 130 to contact the main axis thus to allow its front end to pivot upward when the lower end goes down, a braking axis 140 positioned to pass through the main axis 211 and the bracket 130 and toward the back wheel 160, contacting or leaving the back wheel 160 while being across the front end of the lever 120 and simultaneously traveling according to pivoting of the lever 120, and a coil spring 150 for providing the force of resilience in the direction of pushing the braking axis 140 with the back wheel 160.

More specifically, the front end of the bracket 130 is hinge-coupled to the back end of the main axis 211 so that the back end of the bracket 130 can pivot upward and downward with respect to the main axis 211. The back wheel 160 is equipped under the lower side of the bracket 130. Therefore, when the user gets on the right and left footholds 213R and 213L, the load is transferred to the back wheel 160 through the main axis 211 while the hinge-coupled bracket 130 pivots toward the main axis 211 by means of the load to release braking. On the contrary, when the user gets off the right and left footholds 213R and 213L, the bracket 130 pivots in the direction facing away the main axis 211 by means of the force of resilience of the coil spring 150 while braking is achieved, as will be described hereinbelow in more detail.

Furthermore, the lever 120 is equipped on the upper side of the bracket 130. The intermediate portion of the bracket 130 in length is hinge-coupled to the intermediate portion of the lever 120 in length. The back end of the lever 120 is positioned to contact the lower side of the back end of the main axis 211. Therefore, when load is transferred to the main axis 211, the back end of the lever 120 is pressed by means of the main axis 211 and the front end of the lever 120 relatively pivots upward, while the bracket 130 pivots toward the main axis 211.

An aperture 121 is formed at the front end of the lever 120 in the longitudinal direction of the lever 120. The braking axis 140 is inserted in the aperture 121. In this case, on the basis of the lever 120, a first nut 141 is coupled on the upper end of the braking axis 140. When the front end of the lever 120 pivots upward, the first nut 141 interferes with the front end of the lever 120 to move the braking axis 140 upward. In other words, when load is given to the main axis 211, the back end of the lever 120 goes down relatively and the front end thereof goes up. While the front end of the lever 120 goes up, the braking axis 140 goes up to face away the back wheel 160.

In addition, the lower side of the bracket 130 is equipped with an upper case 161 of the back wheel 160. In the upper case 161, two bearings 163 are stacked. Around the bearings 163, two semicircular coil springs 165 are placed in a circular shape. The bearings 163 enable the lower case 167 to be able to rotate with respect to the upper case 161 thereof.

The lower case 167 of the back wheel 160 is inserted in the upper case 161 in a matching manner. Thereafter, a caster bolt 175 passes through the lower case 167 and the upper case 161 and is then screwed up with a second nut 131 on the upper side of the bracket 130.

As described above, the caster bolt 175 is screwed up with the second nut 131 after passing through the lower case 167 and the upper case 161, thereby leading to an assembly made of the lower case 167 and the upper case 161. As shown in FIGS. 9 and 10, the back end of the upper case 161 is fixed to the bracket 130, so that the back wheel 160 is equipped underneath the bracket 130.

In addition, a protrusion 171 is formed on the lower case 167 to be inserted between the two coil springs 165. The lower case 167 is provided with a pair of flat iron pieces 169 positioned on both sides of the back wheel 160 in parallel. The back wheel 160 is rotatably equipped between the pair of the flat iron pieces 169.

When the direction of the lower case 167 is changed together with the back wheel 160, the protrusion formed on the lower case 167 presses either of the two coil springs 165 depending on the changed direction. In this case, the force of resilience of the coil springs 165 acts in a restoring manner in the direction in which the back wheel 160 goes straight. Furthermore, while the coil springs 165 shrink at its maximum, the lower case 167 can not rotate any more. Here, the angle at which the lower case 167 can rotate is up to 150 degrees.

In addition, the caster bolt 175 is formed with a hollow through which the braking axis 140 passes. The braking axis 140 also passes through the aperture 121 of the lever 120. The first nut 141 is coupled on the upper end of the braking axis 140 so that the braking axis 140 is caught by the lever 120 without leaving the aperture 121 of the lever 120.

In the hollow of the caster bolt 175, a straight elastic coil spring 150 is located. While the braking axis 140 passes through the coil spring 150, the upper end of the coil spring 150 is caught by a stop formed on the inner side of the hollow of the caster bolt 175 and the lower end of the coil spring 150 is caught by a stop 143 formed on the lower side of the braking axis 140.

Hereinafter, the braking mechanism of the automatic brake configured as described above will be described.

A user gets on the right and left footholds 213R and 213L of the step board 200. The load is then transferred to the main axis 211. While the back wheel 160 contacting the ground receives the load, the bracket 130 pivots upward. When the bracket 130 pivots upward, the lower end of the lever 120 equipped on the upper side of the bracket 130 contacts the main axis 211, relatively causing the front end of the lever 120 to move upward.

In this case, the first nut 141 screwed to the upper end of the braking axis 140 interferes with the front end of the lever 120, so that the lever 120 pushes the braking axis 140 upward to release braking. When the braking axis 140 moves upward, the coil spring 150 encompassing the braking axis 140 is compressed while the force of resilience is generated to push the braking axis 140 toward the back wheel 160.

While braking is released as described above, the user runs on his step board. When he gets in danger in running on his step board and gets off the footholds, the braking axis 140 moves toward the back wheel 160 by means of the force of resilience of the coil spring 150 then to contact the back wheel 160. In this case, the first nut 141 interferes with the front end of the lever 120 which in turn pivots downward. On the contrary, the back end of the lever 120 pivots upward while pushing the main axis 211 upward to lead to the bracket 130 to pivot downward.

As such, while the braking axis 140 contacts the back wheel 160 by means of the force of resilience of the coil spring 150, friction which contributes to braking occurs between the braking axis 140 and the back wheel 160.

In addition, the front wheel 162F and the right and left wheels 162R and 162L are first direction restoring casters. As compared to the configuration of the back wheel 160, a second direction restoring caster, the upper case 161 of the front wheel 162F and the right and left wheels 162R and 162L is fixed onto the main axis 211 and the lower side of the right and left footholds 213R and 213L, respectively. In the upper case 161, two bearings 163 are stacked. While the lower case 167 and the upper case 161 are assembled by means of the caster bolt 175, the protrusion formed on the lower case 167 is inserted between the two semi-circular coil springs 165 positioned around the bearings 163.

Therefore, as the front wheel 162F and the right and left wheel 162R and 162L rotate up to 150 degrees as the back wheel 160 does, the protrusion 171 presses either of coil springs, so that the wheels 162F, 162R and 162L receive the force to be restored by means of the force of resilience of the compressed coil spring.

As such, since the front wheel 162F, the right and left wheel 162R and 162L and the back wheel 160 are 150 degrees rotatable direction restoring casters, quick rotation of 360 degrees is quickly achieved when a user intends to rotate his step board with a center at any one of the right and left wheels 162R and 162R.

Meanwhile, a difference between the front wheel 162F, the right and left wheels 162R and 162L is that the upper case 161 is fixed while being twisted by 10 to 20 degrees with respect to the lower side of the right and left footholds 213R and 213L in order to enhance the force of propulsion of the right and left wheels 162R and 162L, as described above.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

In the claims, any reference numerals placed between parentheses in the claims shall not be construed as limiting the claims. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A step board, characterized by comprising:
a first frame (210) in which directional casters (162F, 160) are equipped at the front end and the back end of a main axis (211), respectively, a left foothold (213L) being extending left upward from the middle of the main axis (211) in length, and a right foothold (213R) extending right upward therefrom;
a second frame (220) crossing the main axis and extending in the right and left directions, a directional caster (162R and 162L) being provided at each of the right and left ends thereof, and hinge (223)-coupled to the first frame; and
a plurality of coil springs (230) one end of which is coupled to the first frame (210) and the other end of which is coupled to each of the left and right sides of the second frame (220).

2. The step board as claimed in claim 1, characterized in that a lug (215) extending upward is formed on the main axis and a projection (221) extends upward from the second frame, the projection and the rug being hinge (223)-coupled.

3. The step board as claimed in claim 1, characterized in that the directional casters (160, 162F, 162L and 162R) are direction restoring casters equipped with a plurality of coil springs therein so that the wheels return to their original state by means of the force of resilience.

4. The step board as claimed in claim 4, characterized in that each of the direction restoring casters provided on the right and left ends of the second frame is equipped to be widened forward and narrowed backward against each other gradually with respect to the center line of the main axis.

5. The step board as claimed in claim 1, characterized in that the right and left footholds are formed to have a front side lower than the back side to be inclined.

6. The step board as claimed in claim 5, characterized in that the right and left footholds are formed to have an inner side lower than the outer side to be inclined.

7. The step board as claimed in claim 1, characterized in that the back end of the main axis is provided with a braking means (219) extending toward the side facing away the directional caster (160) equipped at the back end thereof, and placed toward the ground.

8. The step board as claimed in claim 1, characterized in that the step board further comprises an automatic braking device (100) which releases braking of the directional caster equipped at the back end of the main axis when a load is given on the right and left footholds and brakes the directional caster equipped at the back end of the main axis when the load is removed.
